(19) United States
(12) Patent Application Publication
(10) Pub. No.: US 2018/0335820 A1
(43) Pub. Date: Nov. 22, 2018

(54) POWER SUPPLY

(71) Applicant: WAGO Verwaltungsgesellschaft mbH, Minden (DE)

(72) Inventor: Andreas HALTER, Bueckeburg (DE)

(73) Assignee: WAGO Verwaltungsgesellschaft mbH, Minden (DE)

(21) Appl. No.: 15/981,176

(22) Filed: May 16, 2018

(30) Foreign Application Priority Data
May 16, 2017 (DE) 10 2017 004 689.1

(51) Int. Cl. G06F 1/26; G06F 1/32

(52) U.S. Cl. CPC G06F 1/266; G06F 1/3287; G06F 1/263

(57) ABSTRACT

A power supply for supplying power to a load through a supply line is provided, having an electrical energy storage device for supporting the supply of power. The power supply is equipped to determine a number of measured values as a function of at least the electrical energy storage device, and to determine data based on the number of measured values, and the power supply has a communication unit for transmitting the data through an output for connection of the supply line.

This nonprovisional application claims priority under 35 U.S.C. § 119(a) to German Patent Application No. 10 2017 004 689.1, which was filed in Germany on May 16, 2017, and which is herein incorporated by reference.

### BACKGROUND OF THE INVENTION

### Field of the Invention

The present invention relates to a power supply for supplying energy to a load. In particular, the present invention relates to a power supply having an energy storage device for supporting energy supply to a load.

### Description of the Background Art

Power supplies convert an input voltage and/or an input current into a higher or lower output voltage and/or a lower or higher output current, and in so doing make it possible to supply energy to devices or assemblies that require different voltages and currents than are provided by the power grid. In addition, power supplies equipped with an energy storage device can be used to temporarily support the supply of energy.

### SUMMARY OF THE INVENTION

It is therefore an object of the present invention to provide an improved power supply and an improved method for supporting the supply of power to a data processing unit using an electrical energy storage device.

A power supply according to an exemplary embodiment of the invention for supplying power to a load through a supply line using an electrical energy storage device for supporting the supply of power is equipped to determine a number of measured values as a function of at least the electrical energy storage device and to determine data based on the number of measured values. A power supply according to the invention additionally has a communication unit for transmitting the data through an output for connection of the supply line.

In this context, the term “power supply,” can be understood to mean, for example, a device that converts an input voltage and/or an input current into a higher or lower output voltage and/or a lower or higher output current. For example, the power supply can be a switched-mode power supply that converts, e.g., an AC supply voltage into a 12 volt or 24 volt DC voltage.

Furthermore, the term “supply line,” can be understood to mean, for example, an electrical line that is equipped to supply energy to the load in operation by means of current flowing through the line. In addition, the term “electrical energy storage device,” can be understood to mean, for example, an energy storage device that is equipped to store energy chemically (e.g., by means of primary or secondary cells) or electrically (e.g., by means of a capacitor) and to permit drawing of electrical energy from the energy storage device.

Moreover, the term “communication unit,” can be understood to mean, for example, a device that transmits data by means of electrical signals. In this context, the term “supply line,” can be understood to mean, for example, a two-wire line with which the data is transmitted, e.g., by means of a change in the differential voltage between the wires controlled by the communication unit.

Preferably, the power supply and the load are included in a system, wherein the load is implemented as a data processing unit and is equipped to switch to a certain operating state in response to the transmitted data.

The term “data processing unit,” can be understood to mean, for example, a device that derives instructions from data that is provided. Furthermore, the term “operating state,” can be understood to mean, for example, the totality of all operating parameters that can be controlled by the data processing unit.

The data processing unit can be equipped to control a process and, in response to the transmitted data, to terminate the process or to transfer the process to a certain operating state if the transmitted data indicates that the data processing unit is being supplied with energy from the energy storage device and/or that a quantity of energy stored in the energy storage device is below a threshold value.

The term “process,” can be understood to mean, for example, a sequence of system state changes predefined according to a process plan that are or can be actively controlled.

The data processing unit can be equipped to reduce its energy consumption in response to the transmitted data if the transmitted data indicates that the data processing unit is being supplied with energy from the energy storage device.

For instance, the data processing unit can delay or suspend tasks to be executed.

Preferably, the reduction of the energy consumption includes the switching-off of modules of the data processing unit.

For example, modules that are less important, e.g., modules that are not immediately needed for process control, can be switched off.

The method according to the invention comprises a monitoring of an energy supply of the data processing unit and, in response to an existing or imminent undersupply to the data processing unit, a provision of energy from the energy storage device to compensate for the undersupply to the data processing unit, and a provision to the data processing unit of data regarding a state of the energy storage device, wherein the energy and the data are provided over a common line.

In this connection, the term “common line,” can be understood to mean, for example, a line such as, e.g., a two-wire line that is also used for data transmission in addition to the provision of energy, for example a 12 volt or 24 volt differential voltage (supply voltage) between the wires.

Preferably, the provision of energy and data over a common line comprises a modulation of a data signal onto a supply voltage produced by the energy storage device that is applied to the common line.

The modulation can be based on, e.g., “on-off keying,” wherein the state of the energy storage device is signaled by a time interval between voltage oscillations.

Preferably, the transmitted data relates to a state of the energy storage device, and, in response to the transmitted data, the data processing unit reduces its energy consumption and/or terminates a process it controls or transfers a process it controls to a certain operating state.

For example, the transmitted data can relate to an energy content of the energy storage device, and the data processing unit can reduce its energy consumption if the energy content drops below a predetermined threshold value. In addition, the data processing unit can monitor a decrease in the energy content of the energy storage device and determine how long the energy content of the energy storage device allows operation of the data processing unit. If an expected remaining operating time drops below a predetermined threshold value, the data processing unit can transfer a process it controls to a predetermined operating state in order to prevent a loss of control over the process.

Preferably, the reduction of the energy consumption can include the switching-off of modules of the data processing unit.

For instance, the data processing unit can switch off modules that are not used for control of the process in order to extend a remaining operating time made possible through supply of power from the energy storage device.

Preferably, the method additionally comprises a connection of the energy storage device and of the data processing unit to the energy supply, a charging of the energy storage device, and supplying the data processing unit with energy provided by the energy supply.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a system that includes a power supply having an electrical energy storage device for supplying power to a load through a supply line;

FIG. 2 shows a schematic diagram of voltage supply and a schematic diagram of energy storage device discharge current;

FIG. 3 shows the schematic diagram of energy storage device discharge current from FIG. 2 and a data signal modulated onto a supply voltage; and

FIG. 4 shows a flow chart of a process for supporting a supply of power to a data processing unit with the electrical energy storage device.

In the drawings, identical or similar elements are labeled with identical reference characters.

### DETAILED DESCRIPTION

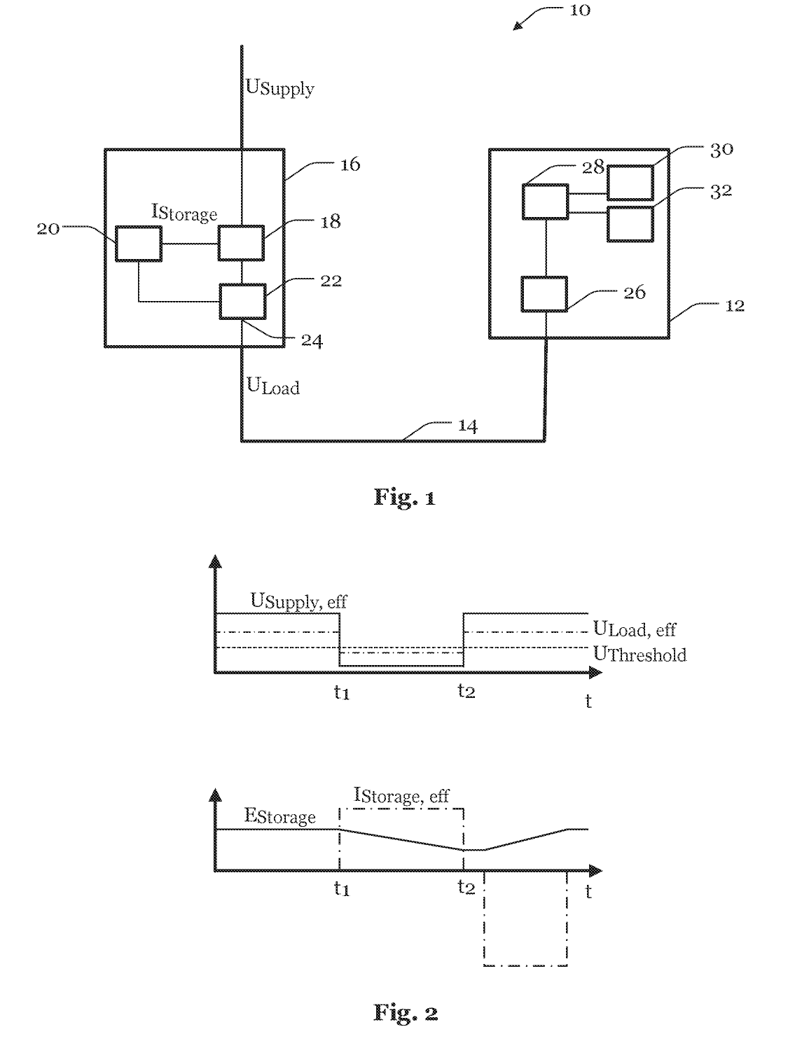

FIG. 1 shows a system 10 with a load 12 that is connected to a power supply 16 through a supply line 14. The power supply 16 is supplied at its input with a line voltage U_{supply}, and provides a supply voltage U_{Last} at its output for supplying the load 12. For example, the power supply 16 can be supplied with an AC voltage of effectively 230 volts at its input and can provide a DC voltage of 24 volts or 12 volts at its output.

The power supply 16 includes a circuit 18 for converting the input voltage. For example, the power supply 16 can be implemented as a switched-mode power supply and can include an electronic circuit 18. The electronic circuit 18 can be equipped, e.g., to rectify the line voltage and to convert the rectified line voltage into a high-frequency AC voltage (for example, by means of a transistor). The high-frequency AC voltage can then be converted into the supply voltage U_{Load} at its output, for example by means of a transformer and a rectifier.

The power supply 16 includes an electrical energy storage device 20 or electrical contacts for connection of an electrical energy storage device 20 for supporting the supply of power to the load 12. If the supply voltage U_{Load} threatens to drop below a predetermined voltage threshold U_{Threshold} or if the supply voltage U_{Load} has fallen below the voltage threshold, the supply voltage U_{Load} can be supported by drawing energy from the energy storage device 20.

For example, the load 12 can be connected to the energy storage device 20 by closing an electronic switch. For instance, the power supply 16 can be equipped to monitor the line voltage U_{Supply} and, if the line voltage U_{Supply} drops below a threshold, to close an electronic switch that connects the load 12 to the energy storage device 20. The load 12 can be connected to the energy storage device 20 while bypassing the electronic circuit 18, or, as is shown in FIG. 1, through the electronic circuit 18 or through parts of the electronic circuit 18. For example, the energy storage device can be connected to the transistor of the electronic circuit 18 in order to stabilize/raise a DC voltage applied to the transistor.

For this purpose, FIG. 2 shows, by way of example, a schematic curve of the line voltage U_{Supplyz,eff}, the supply voltage U_{Load}, the energy content of the energy storage device 20 E_{Storage}, and the energy storage device current I_{Storage}. If the line voltage U_{Supply} collapses at the time t₁, and as a result the supply voltage U_{Load} drops below the voltage threshold U_{Threshold}, the power supply 16 connects the load 12 to the energy storage device 20, by which means a complete collapse of the supply voltage U_{Load} can be prevented or delayed.

The supply voltage U_{Load} generated by the energy storage device 20 can be lower than the supply voltage supplied through the line voltage U_{Supply,eff}, as is shown in FIG. 2, for example in order to maintain emergency operation or basic operation of the load 12. Alternatively, the supply voltage U_{Load} generated by the energy storage device 20 can be equal to the supply voltage U_{Load} generated by the line voltage U_{Supply,eff}. Moreover, the supply voltage U_{Load} generated by the energy storage device 20 can be controlled on the basis of data transmitted from the load 12 to the power supply 16, as is described below in greater detail.

If the load 12 is supplied with energy from the energy storage device 20, the energy storage device 20 is drained by the energy storage device current I_{Storage} until the line voltage U_{Supply,eff} is reestablished at the time t₂, and in response thereto the power supply 16 disconnects the connection between the load 12 and the energy storage device 20 once again. In this state, the energy storage device 20 can be replenished by the energy supplied by the power grid. If the energy storage device 20 is completely drained before the line voltage U_{Supply,eff} can be reestablished, the supply voltage U_{Load} collapses.

In order to permit a controlled transition of the load 12 into the unpowered state before the collapse of the supply voltage U_{Load}, the power supply 16 includes a communication unit 22 that is equipped to determine or receive measured values concerning the energy storage device 20 and to transmit data derived therefrom to the load 12 through an output 24 of the communication unit 22 to which the supply line 14 is connected.

For example, the data can include information regarding the remaining energy content E_{Storage} of the energy storage device 20 or the back-up time remaining (for a constant energy storage device current I_{Storage,eff}). Moreover, the communication unit 22 can be equipped to transmit data relating to the availability of the energy storage device 20 during normal operation, i.e., when the supply voltage U_{Load} is provided by the power grid.

For example, the data can indicate that the energy storage device 20 is operating faultlessly and/or whether the energy storage device 20 is (fully) charged. The transmission of the data in this case takes place, for example, through a data signal that is modulated onto a supply voltage generated by the energy storage device 20 or by the electronic circuit 18, wherein the modulated data signal can be separated from the supply voltage or damped on the load side, for example by means of a filter, in order to prevent/reduce interference with the supply of power to the load 12.

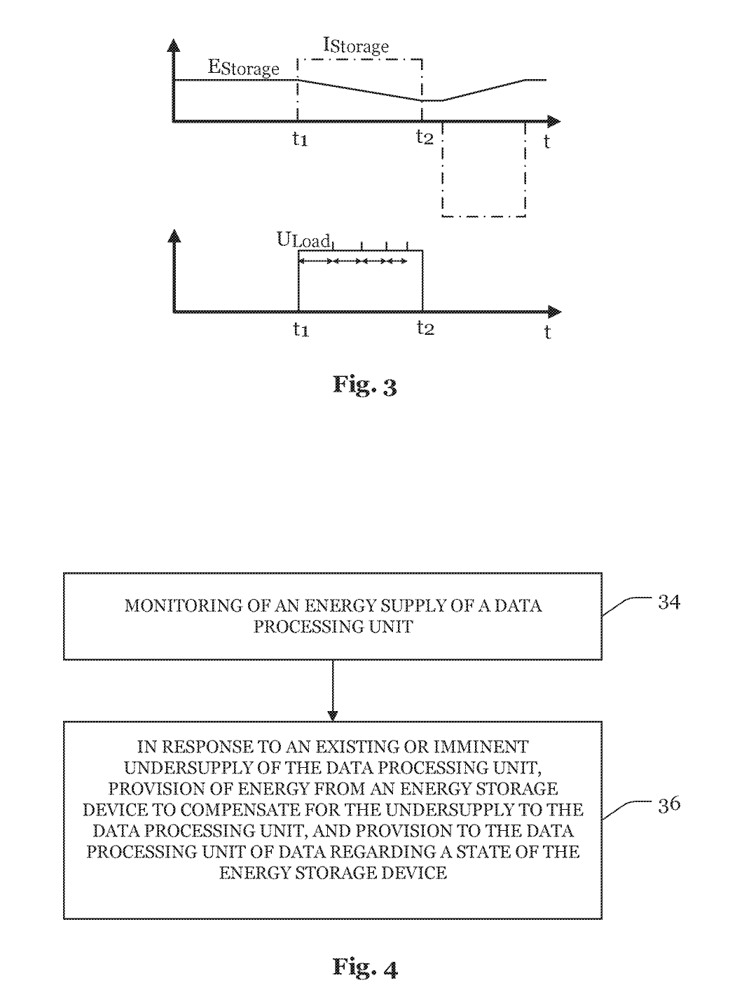

FIG. 3 shows by way of example how low-amplitude voltage pulses can be selectively applied to the supply voltage U_{Load} to transmit data when supplying the load 12 with energy from the energy storage device 20. For example, as is shown schematically in FIG. 3, intervals between the voltage pulses can indicate the state of charge of the energy storage device 20, wherein, e.g., a first interval is associated with a first state of charge and a second, shorter interval is associated with a second, lower state of charge. Moreover, instead of an interval between voltage pulses, the amplitude of the voltage pulses can also be selectively changed to indicate the state of charge of the energy storage device 20, for example in that the size of the amplitude correlates with the state of charge of the energy storage device 20.

It is a matter of course, however, that the transmission of data is not restricted to the stated examples; rather, in principle any intentional change in the supply voltage U_{Load} that is reliably detectable by the load 12 within the framework of the interfering influences that are to be expected can be used to signal the state of charge of the energy storage device 20. For example, if random interference-induced variations of the supply voltage U_{Load} within a specific voltage range are to be expected, the data can be transmitted by generating supply voltage values U_{Load} outside the specific voltage range.

Moreover, if periodic interference-induced variations of the supply voltage U_{Load} at specific frequencies or in a specific frequency range are to be expected, the data can be transmitted by generating variations in the supply voltage values U_{Load} outside the specific frequency range. Moreover, the interference and the data signal can be damped by a filter arranged in the load 12, for example a low-pass filter or a bandpass filter, so that the supplying of power to the load 12 is not disrupted by the modulated data signal.

To capture the data, the load 12 includes a communication unit 26 that monitors the supply line 14. Depending on the information transmitted in the data and the nature of the load 12, the load 12 can initiate various steps in response to being supplied with energy from the energy storage device 20. If, for example, the load 12 is implemented as a controller that controls a process, the load 12 can transfer the process to a safe state in response to the back-up operation. If the load 12 is controlled by a higher-level control system, for example, the load 12 can signal the higher-level control system that a failure of the load 12 is to be expected or when it is to be expected.

If the load 12 can be operated in different operating modes, wherein the operating modes require different amounts of power, the load 12 can switch to an operating mode that requires less power than another operating mode in order to maintain basic functionality of the load 12. If the load 12 has a sleep mode, for example, the load 12 can switch to the sleep mode. In addition, the load 12 can transfer data from volatile memories to nonvolatile memories in order to prevent data loss when the supply voltage U_{Load} collapses.

For example, the load 12 can be implemented as a data processing unit 12 and can include a data processing module 28 that is connected to a memory module 30. In response to a collapse of the line voltage U_{Supply} and/or a shortfall in the energy content of the energy storage device 20, the data processing module 28 can save data that is stored in volatile memories in the storage module 30 and thereby save its state. This makes it possible, for example, for the data processing unit 12 to return to its previous (saved) state by appropriately writing to the volatile memory when the supply voltage U_{Load} is reestablished.

Moreover, the load 12 can include an additional module 32, for example a self-diagnostic or monitoring module, that can be switched off in response to a collapse of the line voltage U_{Supply} and/or a shortfall in the energy content of the energy storage device 20 in order to prevent or delay a failure of the data processing module 28. Furthermore, if the load 12 includes redundant modules for increasing its availability or for error-detection, the redundant modules can be shut off to extend the duration of availability.

FIG. 4 shows a flow chart of essential steps of the procedure described above. The procedure begins at 34 with the monitoring of the energy supply to the data processing unit 12. The monitoring in this case is carried out in particular by the power supply 16, for example by the means that the circuit 18 monitors the line voltage U_{Supply} and/or the supply voltage U_{Load}. If the effective line voltage U_{Supply,eff} and/or the effective supply voltage U_{Load,eff} fall below a predefined threshold or thresholds, the power supply 16 can switch the supplying of the data processing unit 12 from line operation to backup operation, wherein the data processing unit 12 is supplied with power from the energy storage device 20 in back-up operation.

The procedure is continued at 36 in that, in back-up operation, data concerning the state of the energy storage device 20 is transmitted to the data processing unit 12, wherein energy and data are provided over a common line 14. The data can be used by the data processing unit 12 as described above to prevent a sudden, uncontrolled failure of the data processing unit 12.

Moreover, the data processing unit 12 can transmit data through the line 14 to the power supply 16 or to other data processing units 12 that are connected to the power supply 16, wherein the data includes, e.g., an expected energy consumption of the data processing unit 12 from which the power supply 16 (or the other data processing units 12 that are connected to the power supply 16) can determine the time within which a supply of power to the data processing unit(s) 12 can be guaranteed.

Moreover, the power supply 16 can have still another output (not shown) at which a supply voltage is likewise provided, but wherein this supply voltage is not supported by the energy storage device 20. In this way a supply voltage can be provided for loads whose sudden, uncontrolled failure is acceptable, wherein these loads do not load the energy storage device 20 when required.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A power supply for supplying power to a load via a supply line, the power supply comprising:
an electrical energy storage device for supporting a supply of power; and
a communication unit for transmitting data through an output for connection of the supply line,
wherein the power supply is adapted to determine a number of measured values as a function of at least the electrical energy storage device, and
wherein the power supply is adapted to determine the data based on the number of measured values.

2. A system comprising:
a power supply according to claim 1; and
a load, wherein the load is a data processing unit and is adapted to switch to a certain operating state in response to the transmitted data.

3. The system according to claim 2, wherein the data processing unit is adapted to control a process and, in response to the transmitted data, to terminate the process or to transfer it to a certain operating state if the transmitted data indicates that the data processing unit is being supplied with energy from the energy storage device and/or a quantity of energy stored in the energy storage device is below a threshold value.

4. The system according to claim 2, wherein the data processing unit is adapted to reduce its energy consumption in response to the transmitted data if the transmitted data indicates that the data processing unit is being supplied with energy from the energy storage device.

5. The system according to claim 4, wherein the reduction of energy consumption includes a switching-off of modules of the data processing unit.

6. A method for supporting a supply of power to a data processing unit using an electrical energy storage device, the method comprising:
monitoring an energy supply of the data processing unit; and
providing, in response to an existing or imminent undersupply of the data processing unit, energy from the electrical energy storage device to compensate for the undersupply to the data processing unit; and
providing the data processing unit with data regarding a state of the electrical energy storage device, the energy and the data being provided over a common line.

7. The method according to claim 6, wherein the provision of energy and data over a common line comprises a modulation of a data signal onto a supply voltage that is produced by the energy storage device and that is applied to the common line.

8. The method according to claim 6, wherein the transmitted data relates to a state of the energy storage device, and, in response to the transmitted data, the data processing unit reduces its energy consumption and/or terminates a process it controls or transfers the process to a certain operating state.

9. The method according to claim 8, wherein the reduction of the energy consumption comprises a switching-off of modules of the data processing unit.

10. The method according to claim 6, further comprising:
connecting the energy storage device and the data processing unit to the energy supply;
charging the energy storage device; and
supplying the data processing unit with energy provided by the energy supply.
